(19) United States
(12) Patent Application Publication
(10) Pub. No.: US 2023/0162736 A1
(43) Pub. Date: May 25, 2023

(54) TRAINING, EDUCATION AND/OR ADVERTISING SYSTEM FOR COMPLEX MACHINERY IN MIXED REALITY USING METAVERSE PLATFORM

(71) Applicant: INHA University Research and Business Foundation, Incheon (KR)

(72) Inventors: Geun Sik Jo, Incheon (KR); Aziz Siyaev, Incheon (KR)

(21) Appl. No.: 17/566,871

(22) Filed: Dec. 31, 2021

(30) Foreign Application Priority Data
Nov. 24, 2021 (KR) 10-2021-0163052

(51) Int. Cl. G10L 15/26; G06N 3/04; G06F 3/16; G06F 40/242; G10L 15/08; G10L 15/06

(52) U.S. Cl. CPC G10L 15/26; G06N 3/04; G06F 3/167; G06F 40/242; G10L 15/083; G10L 15/063

(57) ABSTRACT

Proposed is a training, education and/or advertising system for complex machinery in mixed reality (MR) using metaverse. The system includes a simulation execution unit configured to perform three-dimensional (3D) simulations by providing a digital twin for performing simulations on a specific visual component for the maintenance training, education and/or advertising through smart glasses, a training unit configured to provide artificial intelligence (AI) knowledge based on training information comprising two-dimensional (2D) manuals, task instructions of the 2D manuals, and a simulation cost model (SCM), and a neuro-symbolic speech executor (NSSE) configured to perform a neural network task and symbolic reasoning for processing a speech request in order to perform the 3D simulations based on the provided AI knowledge and the digital twin and to notify a user of the processing and completion of the requested task by transmitting visual and speech feedback to the user.

### CROSS-REFERENCES TO RELATED APPLICATIONS

This application is based on and claims priority under 35 U.S.C. 119 to Korean Patent Application No. 10-2021-0163052, filed on Nov. 24, 2021 in the Korean intellectual property office, the disclosures of which are herein incorporated by reference in their entireties.

### TECHNICAL FIELD

The present disclosure relates to a metaverse platform for providing a legacy manual, a three-dimensional (3D) model, a 3D simulator and (e.g., Boeing-737 aircraft maintenance training and education) maintenance knowledge of complex machinery, such as an aircraft.

### BACKGROUND OF THE DISCLOSURE

Extended reality (XR) encompasses real-and-virtual merged environments and may include, but are not limited to, virtual reality (VR), augmented reality (AR), augmented virtuality (AV), mixed reality (MR), and any combination of XR with speech recognition. The merging of these different environments can bring enormous value to various aspects of people's lives and industries. The benefits provided by XR can include helping people with disabilities, improving an education process, or easing a workflow in the industry, among others.

One proposed use for XP technology includes a method of solving communication problems among deaf, hearing impaired, or hard of hearing people using AR and speech recognition technologies. Illustrating a narrator's speech for display to deaf people by generating real-time Augmented Reality “live subtitles” while hearing a talk, can help them to hear and feel the environment in a visual way, further overcoming a communication barrier between the deaf and other people, who may not know sign language.

In the education field, benefits can be obtained from learning through a combination of AR and speech recognition technologies. One example is learning new languages. In this case, AR may offer an enhanced environment that influences non-native “children's experience and knowledge gain during the language learning process.” AR, together with speech recognition, facilitates enjoyment during learning, and enables young children to interact with virtual objects to cope with certain tasks, such as learning words for basic colors, 3D shapes, and spatial objects relationships faster and easier.

Still further, various operations at an industrial workflow can be automated or enhanced through XR and speech recognition. XR helps to simulate or digitalize a working process, speech commands help to control operations, thereby saving the time and being a flexible, efficient, and economical form of communication.

In a conventional technology, the concept of an implementation of AR and speech interface for controlling lifting devices has been presented, thereby eliminating the need to be physically present in a site for crane works. In another example, MR aircraft maintenance can be facilitated with speech commands, where a digital twin of aircraft is used instead of a real aircraft.

Other examples of XR include the following:

[1] K. Yi, J. Wu, C. Gan, A. Torralba, P. Kohli, and J. B. Tenenbaum, “Neural-symbolic vqa: Disentangling reasoning from vision and language understanding,” in Advances in Neural Information Processing Systems, 2018, pp. 1039-1050.

[2] C. Han, J. Mao, C. Gan, J. Tenenbaum, and J. Wu, “Visual concept-metaconcept learning,” in Advances in Neural Information Processing Systems, H. Wallach, H. Larochelle, A. Beygelzimer, F. d'Alche-Buc, E. Fox, and R. Garnett, Eds., vol. 32. Curran Associates, Inc., 2019. [Online].

Available:https://proceedings.neurips.cc/paper/2019/file/98d8a23fd60826a2a474c5b4f5811707-Paper.pdf [3] J. Mao, C. Gan, P. Kohli, J. B. Tenenbaum, and J. Wu, “The neuro-symbolic concept learner: Interpreting scenes, words, and sentences from natural supervision,” in 7th International Conference on Learning Representations, ICLR 2019, New Orleans, LA, USA, May 6-9, 2019. OpenReview.net, 2019. [Online]. Available: https://openreview.net/forum? id=rJgMlhRctm

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present disclosure are intended to provide a metaverse for training and education related to mechanical systems (e.g., of Boeing-737 aircraft maintenance) which provide a legacy manual, a 3D model, a 3D simulator and/or maintenance knowledge. Furthermore, embodiments of the present disclosure provide a context recognition voice understanding module neuro-symbolic speech executor (NSSE) for searching and controlling a workflow of a metaverse in which maintenance manuals are strictly observed.

In an aspect, the present disclosure proposes a system for complex machinery in mixed reality (MR) using metaverse. The system for complex machinery in MR using metaverse includes a simulation execution unit configured to perform three-dimensional (3D) simulations in a metaverse mixed reality (MR) by providing a digital twin for performing simulations on a specific visual component for at least one of maintenance training, education and advertising of machinery comprising an aircraft through smart glasses, a training unit configured to provide artificial intelligence (AI) knowledge based on training information including at least one of two-dimensional (2D) manuals, task instructions of the 2D manuals, and a simulation cost model (SCM), and a neuro-symbolic speech executor (NSSE) configured to perform a neural network task and symbolic reasoning for processing a speech request in order to perform the 3D simulations based on the provided AI knowledge and the digital twin and to notify a user of the processing and completion of the requested task by transmitting visual and speech feedback to the user.

The NSSE according to an embodiment of the present disclosure includes a dynamic length audio recorder configured to detect a trigger syntax when a user who wears smart glasses triggers the NSSE in order to record his or her audio request, invoke a dynamic audio length recording (DLAR) algorithm and to process the DLAR algorithm so that audio data is generated from a speech signal stream outputted by a microphone, a speech-to-text network configured to convert the audio data into text and deliver the text to a text-to-programs network in a speech-to-text form for automatic speech recognition, wherein the speech-to-text network is an automatic speech recognition neural network, the text-to-programs network consisting of functions and parameters and configured to convert the speech-to-text into an executable program sequence of a domain-specific language, and a symbolic programs executor configured to notify the user of the processing and completion of the requested task by transmitting visual and speech feedback to the user.

The text-to-programs network converts a word in the text into a request vector by using a general vocabulary for matching the word in the text to a word in an education dataset and converts the request vector into a program vector, and the program vector includes referencing to a component of the domain-specific language used to generate a program. The symbolic programs executor uses programs to be executed as an input, wherein each of the programs consists of functions and corresponding parameters, extracts functions and parameters when an iteration is inputted with respect to each of given programs, appends a variable (Prey) describing a result of a previous iteration to the parameters, invokes the respective functions when functions and parameters are prepared and delivers the extracted parameters through Execute functions, and updates the variable (Prey) in each iteration because each function has a return value. The procedure is applied to all programs.

In another aspect, in the present disclosure proposes a method in mixed reality (MR) using a metaverse platform, including steps of: performing, by a simulation execution unit, three-dimensional (3D) simulations in a metaverse mixed reality (MR) by providing a digital twin for performing simulations on a specific visual component for at least one of maintenance training, education and advertising through smart glasses; providing, by a training unit, artificial intelligence (AI) knowledge based on training information including at least one of two-dimensional (2D) manuals, task instructions of the 2D manuals, and a simulation cost model (SCM); and performing, by a neuro-symbolic speech executor (NSSE), both a neural network model and symbolic AI knowledge reasoning for processing a speech request in order to perform the 3D simulations based on the provided AI knowledge and the digital twin and notifying a user of the processing and completion of the requested task by transmitting visual and speech feedback to the user.

The context recognition voice understanding module neuro-symbolic speech executor (NSSE) according to embodiments of the present disclosure, unlike the existing speech recognition method, can understand a request and answer of a user based on context and an aircraft-related knowledge by applying neuro-symbolic artificial intelligence in which a neural network and traditional symbolic reasoning are combined. Furthermore, the proposed aircraft maintenance training and education method and system using metaverse are cost-effective and extensible solutions for an aviation technology because they replace an expensive physical aircraft with a virtual aircraft which can be easily modified and updated. Furthermore, the NSSE playing as a role of a site expert can provide a technical guide and all resources in order to facilitate effective training and education for aircraft maintenance.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a diagram illustrating a configuration of a training, education and/or advertising system for complex machinery in MR using metaverse according to an embodiment of the present disclosure.

FIG. 2 is an exemplary diagram of a first-person view snapshot of aircraft maintenance metaverse according to an embodiment of the present disclosure.

FIG. 3A is an exemplary diagram of an aircraft maintenance manual 3D simulator according to an embodiment of the present disclosure.

FIG. 3B is an exemplary diagram of an aircraft 3D simulator that provides supplementary knowledge according to an embodiment of the present disclosure.

FIG. 4 is a flowchart for describing a complex machinery training, education and/or advertising method in MR using metaverse according to an embodiment of the present disclosure.

FIG. 5 is a diagram illustrating an operating process of a neuro-symbolic speech executor (NSSE) according to an embodiment of the present disclosure.

FIG. 6 is a diagram illustrating a dynamic audio length recording (DLAR) algorithm according to an embodiment of the present disclosure.

FIG. 7 is a diagram illustrating an operating process of a text-to-programs network according to an embodiment of the present disclosure.

FIG. 8 is a diagram illustrating architecture of the text-to-programs network according to an embodiment of the present disclosure.

FIG. 9 is a diagram illustrating an operating process of a symbolic programs executor according to an embodiment of the present disclosure.

FIG. 10 is a diagram illustrating a symbolic programs executor algorithm according to an embodiment of the present disclosure.

FIG. 11 is an example illustrating a process from a sample user request to results according to an embodiment of the present disclosure.

FIG. 12 is a diagram for describing the context management of the NSSE according to an embodiment of the present disclosure.

FIG. 13 is a diagram illustrating architecture of the NSSE according to an embodiment of the present disclosure.

### DETAILED DESCRIPTION

While illustrative embodiments have been illustrated and described, it will be appreciated that various changes can be made therein without departing from the spirit and scope of the disclosure.

In order to develop and embed speech recognition in extended reality (XR), it is crucial to understand the nature of a user request, functionalities in speech communication addresses, and environments for which an application is built. For example, a speech request that consists of only predefined, static, and short-sentenced commands, such as “Play”, “Stop”, “Next Image”, can be easily processed by offline built-in voice control in mobile devices, such as smart glasses HoloLens (HoloLens is a trademark of Microsoft Corporation of Redmond, Wash., in the United States and other locations).

For a user's request that has longer sentences, flexible semantic structures, and refer to the same functionality, classification neural networks may be applied. For example, commands, such as “Show me a next object”, “Display a next object”, “Move to a next item”, map to an action, which displays a next object in order. Thus, a classification model may map voice signal features into one action class out of a set of predefined categories. Usually, convolutional neural network (CNN)-based neural model architecture is utilized for audio classification due to the ability to extract data features. Depending on the type of audio features, 1D or 2D convolution filters are used. In the case of processing raw audio signals, 1D convolution is applied. For Mel Frequency Cepstral Coefficients (MFCC) or log spectrum features, 2D is used. Likewise, in the present disclosure, an implementation of speech commands is concentrated with the help of a custom bilingual CNN neural network that extracts MFCC features from spoken audio data in English and Korean and converts the MFCC features into to one of 8 classes that triggers a certain action to be taken. For example, when “Please, play tutorial video” is selected, a media player starts a reference video. The network takes audio MFCC features and produces a set of results including an action class and an identified language. In this case, speech communication calls operational functions of an application.

In an XR system, there is a case where the transcription of a speech is necessary and audio signals are converted into text with the help of automatic speech recognition (ASR) techniques such as, which built acoustic models for mapping signal waves to sequences. In a conventional technology, a fully convolutional model that receives raw audio as input and that computes speech representations. In another conventional technology, a recurrent neural network (RNN) is used. In still another conventional technology, results are obtained by combining the predictions of an attention-based decoder and a long short term memory (LSTM)-based language model. In the XR system, such networks are used online, not in an actual mobile device because the networks require a space and the processing ability. Nevertheless, the inference of neural models, either classification or ASR networks, does not depend on contextual information. However, in the present disclosure, the case and demand when context matters are processed.

In an embodiment of the present disclosure, aircraft maintenance manuals can be taken into account, which are legal documents that have to be strictly followed by mechanics (in other words, users) because the consequences of operational mistakes during maintenance repair operation (MRO) may be devastating and lethal. Accordingly, for operational control along with speech communication, a strong relationship with manuals that represent contextual information is often necessary. Manuals include knowledge and hierarchy in tasks, subtasks, instructions, aircraft parts, 2D manuals, 3D objects, tools, warnings, cautions, etc. Items in the document are generally linked, thus generating knowledge graphs that need to be referred to during a maintenance process. Accordingly, the development of speech communication and control over simple-structured deep learning networks may not handle all resources and relations in the manuals and may not consider context while inferencing. In general, a speech interaction system needs a logic-based part that reasons based on contextual information and compliments the pattern recognition abilities of neural networks. Recent advancements in the field of neural networks (in other words, neuro-symbolic AI) combine the abilities of both neural networks and symbolic AI for logic-based reasoning.

Neuro-symbolic AI, which is a new methodology for AI, enhances the strengths of statistical AI, such as machine learning, through the complementary capabilities of symbolic or classical AI based on knowledge and reasoning. In this case, the term “neural” refers to the use of artificial neural networks or connectionist systems in the widest sense. The term “symbolic” refers to AI approaches based on explicit symbol manipulation. Neural and symbolic AI approaches differ in the representation of information within an AI system. For symbolic systems, the representations are explicit, manipulated by symbolic means, and understandable by humans. However, in neural systems, representations are usually performed by weighted connections between neurons. Main goals of neuro-symbolic AI are to solve complex problems by the ability to learn on a small amount of data, thus providing users with understandable reasons on each decision and controllable actions, which is crucial when integrating AI in the industry.

The rise of neuro-symbolic AI started with several works that unleashed opportunities of this approach. In a conventional technology, techniques based on neuro-symbolic AI for visual and language understanding to perform the joint learning of concepts from images and related question-answer pairs were suggested. By applying deep learning for visual recognition and language understanding and traditional AI in symbolic program execution for reasoning, the approaches are able to answer various relational and conceptual questions from a given image. In a conventional technology, the Compositional Language and Elementary Visual Reasoning (CLEVR) dataset is used for visual question answering (VQA) systems to reason and answer questions about visual data. Images in the dataset consist of simple 3D shapes, such as a cylinder, a cube, and a sphere. Each object has its own color (e.g., red, green, or blue), material (e.g., rubber or metal), and size (e.g., small or large), and is located in a certain relational position to other objects in a scene (left, right, behind, and in front of a particular object). In order to reason in these scenes, researchers' functional programs for each question in CLEVR were introduced, where a program may be executed on a scene graph, thus giving an answer to a question from an image. The proposed programs include querying, counting, or comparing operations that in combination provide a particular result.

A scheme for performing concept common learning of question and answer pairs related to images based on neuro-symbolic AI for vision and language understanding separates vision and language understanding. First, an image scene is parsed by using neural networks, and a question is interpreted by converting the image scene into functional programs. The parsed image information is structured in knowledge. Next, the reasoning applies symbolic execution of programs based on knowledge to provide an answer to a question. In this scheme, in order to extract structural scene representation, mask R-CNN and CNN networks were applied. In order to process questions and generate programs, a sequence to sequence model using an encoder-decoder bidirectional LSTM encoder is applied. The method having various advantages, such as robustness to complex programs and small training data, achieved excellent accuracy on the CLEVR dataset.

The integration of learning and reasoning is one of key challenges in AI and machine learning today. Furthermore, there are many questions that remain open, such as semantics of neural-symbolic approaches, explainability, potential applications, and being able to generalize to tasks with minimal or no domain-specific training. The research community slowly realizes the inherent limitations of deep learning approaches according to a conventional technology, and additional background knowledge through logical reasoning is provided to further improve deep learning systems. In such methods, in the present disclosure, the works of neural networks are incorporated based on architecture called a transformer.

According to various conventional technologies, the superiority of a transformer over RNNs was demonstrated in natural language processing tasks. The RNNs work by treating natural language as a time series, where every word modifies the meaning of all the words that came before it. The RNN looks at one word at a time and creates a representation to further contextualize that representation with the representation of a next word. When comparing the Transformer and RNN architecture, the Transformer learns sequential information via a self-attention mechanism that processes a sentence as a whole, whereas the RNNs extract representations word by word, which does not allow for parallel processing, so that a training process in the Transformer is more efficient because the training processes may be distributed over multiple GPUs. Furthermore, the transformer does not rely on past states to capture dependencies with previous words, but process a sentence as a whole, and multi-head attention and positional embeddings thereof provide information about the relationship between different words. However, the RNN architecture keeps learned information through past states, where each state is assumed to be dependent only on the previous state, thus causing issues in long dependencies. Accordingly, the Transformer may take a word or even pieces of words and aggregate information from surrounding words to determine the meaning of a given bit of language in context. By taking into account all the advantages of the given approaches, the present disclosure constructs language understanding models, such as speech recognition and translation, based on transformer architecture.

In the metaverse field, it is essential for a speech communication system to recognize context in order to interact with 3D world virtual resources. The present disclosure, in an embodiment, proposes a metaverse for Boeing-737 aircraft maintenance training and education that provides legacy manuals, a 3D model, a 3D simulator and aircraft maintenance knowledge. Furthermore, in order to search and control a work flow of metaverse in which maintenance manuals are strictly followed, the present disclosure provides, in an embodiment, a context recognition voice understanding module neuro-symbolic speech executor (NSSE). The NSSE, unlike the existing speech recognition method, understands requests and answers of users based on context and aircraft-related knowledge by applying a neural network and neuro-symbolic AI combined with traditional symbolic reasoning.

The NSSE was developed as industrially flexible approaches by applying only composite data for training. Even though, an evaluation process of the NSSE performed with various automatic speech recognition metrics for actual user data experimental results demonstrated sustainable results with generalization abilities having average accuracy of 94.7% and Word Error Rate (WER) of 7.5% and the processing of a speech request from a user who is not a native speaker.

The proposed aircraft maintenance training and education method and system using a metaverse are cost-effective and extensible solutions, for example, for aviation technology because they replace expensive physical aircraft with virtual aircraft which may be easily modified and updated. Furthermore, the NSSE playing a role as a site expert may provide technical guidance and all resources in order to facilitate effective training and education for aircraft maintenance. Hereinafter, embodiments of the present disclosure are described in detail with reference to the accompanying drawings.

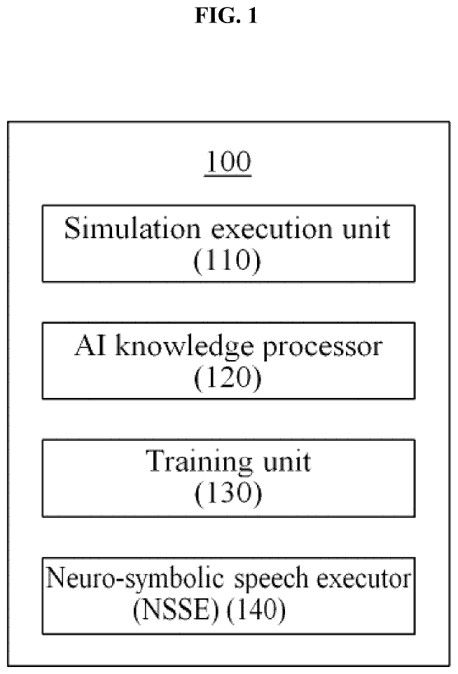

FIG. 1 is a diagram illustrating a configuration of a training, education and/or advertising system for complex machinery in MR using metaverse according to an embodiment of the present disclosure.

The proposed training, education and/or advertising system for complex machinery 100 in MR using metaverse includes a simulation execution unit 110, an artificial intelligence (AI) knowledge processor 120, a training unit 130 and a neuro-symbolic speech executor (NSSE) 140.

The simulation execution unit 110 according to an embodiment of the present disclosure performs simulations by providing a digital twin for performing simulations on a specific visual component for maintenance training, education and/or advertising through smart glasses in metaverse mixed reality (MR) for the maintenance training, education and/or advertising of machinery including an aircraft.

The training unit 130 according to an embodiment of the present disclosure provides AI knowledge from the AI knowledge processor 120 based on training information, including two-dimensional (2D) manuals, task instructions of the 2D manuals and a simulation cost model (SCM).

In an embodiment of the present disclosure, aircraft maintenance training, education and/or advertising are described as examples, but the present disclosure is not limited thereto. The present disclosure may be applied to metaverse MR for various machinery maintenance training, education and/or advertising.

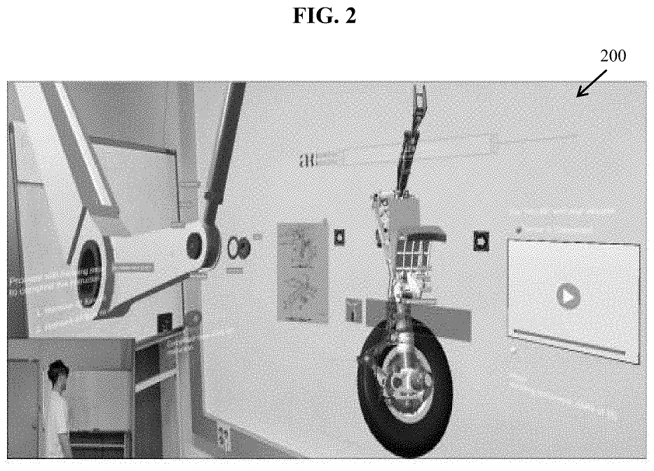

FIG. 2 is an exemplary diagram of a first-person view snapshot of an aircraft maintenance metaverse 200 according to an embodiment of the present disclosure. Aircraft maintenance metaverse 200 is a collaborative space that lets users in the field of maintenance repair operations (MRO) get together to operate on aircraft-specific virtual assets. The metaverse is used to describe the concept of a future iteration of the internet, made up of persistent, shared, 3D virtual spaces linked into a perceived virtual universe.

At the same time, the metaverse proposed in the present disclosure is a learning place where trainees can operate on virtual aircraft having supportive materials and functions that facilitate the maintenance training. The metaverse having all things necessary to perform a job according to virtual manuals creates an effective workflow of training. When considering the fact that the contemporary world is hit by COVID-19 and various industries migrate from traditional works or formal education to online alternatives enhancing Society 5.0, virtual spaces, such as the proposed metaverse, provide potential solutions capable of dealing with the challenges presented by the pandemic. The metaverse creates interoperable gateways to connect worlds, functioning as an all-encompassing, unified portal and hub. In the same manner, in the present invention, the real world is combined with the world of virtual aircraft and maintenance.

When considering the cost of physical airplanes, which may reach more than hundreds of millions of dollars (Boeing-737 costs 100 million dollars), the proposed aircraft maintenance metaverse represents a potential solution for various aviation colleges and schools that arrange training on outdated aircraft models. Virtual models of an aircraft in the metaverse can be easily updated or replaced. In addition, while working on a physical part (i.e., an aircraft landing gear), usually special equipment is required just to transport or install the physical part because the weight of such components is huge. In contrast, various interaction mechanisms using smart glasses let users manipulate assets in an intuitive way with just a touch of fingers. Accordingly, the role of the metaverse in the industry is enormous because a vast amount of resources is reduced.

In order to access the metaverse, smart glasses (e.g., HoloLens 2) are being used. The smart glasses help to project MR onto the real world and to deliver an immersive experience of the 3D world. FIG. 2 illustrates a snapshot of the proposed aircraft maintenance metaverse 200, which is captured from a first-person view, as shown on the left of FIG. 2.

Referring to FIG. 2, it may be seen that various visual components exist. First, a main asset is a particular aircraft part to work on. The particular aircraft part to work on is located in the center and represents a digital twin of an actual physical model. A main landing gear of Boeing-737 is illustrated in FIG. 2. The model has annotations to its component parts to let novice users have visual clues. A media player that demonstrates a video reference is placed on the right to the model. A tutorial video summarizes the job of fellow engineers on a particular task and helps trainees to understand a procedure to be completed. Next, a manual section is demonstrated on the left of the digital twin. The proposed system has kept the existing 2D Aircraft Maintenance Manual and has introduced an innovative 3D simulator.

All procedures implemented in the system are based on official Boeing-737 manuals and documentation because keeping to the defined protocol is crucial for safety and effectiveness. Thus, the first step performed in this project is to convert legacy documents into a structured format to be used in the system. A JavaScript Object Notation (JSON) format is used to encapsulate a massive amount of data and to convert the data into knowledge and also to enhance the concept of the web in the metaverse, which includes the sum of all virtual worlds and the Internet. The system may keep a trusted traditional way of aircraft maintenance, while enhancing procedures based on new dimensions of information, such as MR animations, media content, and 3D manuals that innovates maintenance training and education.

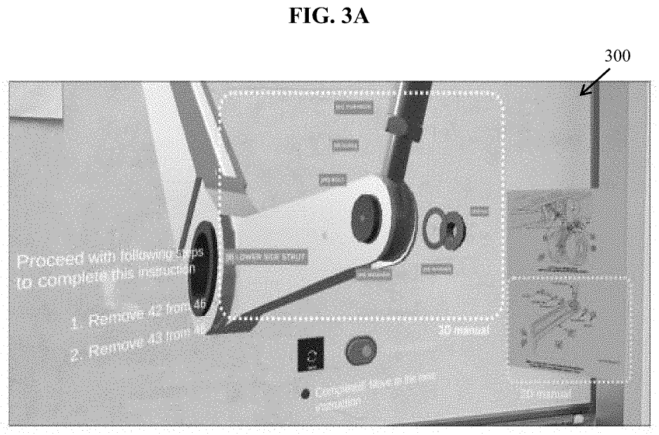

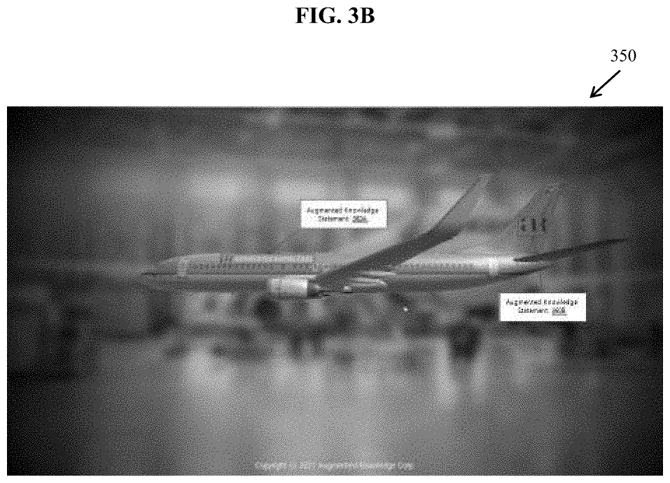

FIG. 3A is an exemplary diagram of an aircraft maintenance manual 3D simulator according to an embodiment of the present disclosure. 3D manual 300 according to an embodiment of the present disclosure represents a new way to look at traditional 2D manuals. In general, the existing 2D manuals have figures that illustrate a certain process with annotations and are static and show the end result as a snapshot. Referring to FIG. 3, an example of a 2D Aircraft Maintenance Manual (AMM) manual is illustrated. FIG. 3 illustrates the lower side strut removal of the main landing gear, where the 2D manual works as a reference on how to perform a particular task during the maintenance process.

The 3D manual 300 is a model that helps to visualize a scene and individual components separately at different angles to better understand the information that is referred to. While introducing new dimensions to look at legacy manuals, there is proposed the 3D manual 300 that completes 2D legacy figures. In FIG. 3, the 3D manual 300 is demonstrated as an addition to its 2D manual, so that a user who refers to the figure may explore the 3D manual 300 in an understandable view.

In addition to an explorable third dimension, the 3D manual 300 has various functionalities. A 2D figure encapsulates information of a task, a subtask, or an instruction, and displays desirable end results, thereby enabling 3D manual intermediate processes to be explored as well. In FIG. 3, 2D represents the end results of subtask execution, which has the following three instructions:
“Remove the nut 42, washer 43 from the bolt 46”.

“Remove the bolt 46 to disconnect the lower side strut assembly”

“Isolate the pushrod 41 from the lower side strut assembly”

In contrast, if the proposed 3D manual 300 is used, a deep view can be seen at the instruction level and can be performed step-by-step. That is, “Remove the nut 42, washer 43 from the bolt 46” in FIG. 3, is divided into two steps of removing 42 from 46 and removing 43 from 46. Accordingly, a user may execute a particular instruction as one or may divide particular instruction into sub-steps as illustrated. When the execution of the step-by-step instruction is performed, a visual clue indicated as a “completed” icon is illustrated so that the process can be better navigated.

Each subtask or instruction has its own 3D manual 300 which may be considered as a simulator to experiment on. In order to control this complex process, speech commands are used, and are processed using the method according to an embodiment of the present disclosure. FIG. 3B is an exemplary diagram of an aircraft 3D simulator 350 that provides supplementary knowledge according to an embodiment of the present disclosure. As illustrated, aircraft 3D simulator 350 includes an overall view of an aircraft, although it should be understood that the view is not limited to an aircraft and the view may include only a portion thereof. In any case, included in the view are a number of augmented knowledge statements 360A, 360B. Augment knowledge statements 360A, 360B provide information to the viewer regarding the portion of the view to which they refer. This information can include technical specifications, design options, possible modifications, cost estimates, promotional materials, advertising information, contact information, and/or any other information that may help the user better understand the overall view. To this extent, each augmented knowledge statement 360A, 360B may include one or more of text, image/logo, audio data, still picture, video data, and/or any other format that may be calculated to convey information for the education and training of the user in the virtual/mixed reality environment. The text, video, or other information in augmented knowledge statement 360A, 360B can be dynamically changed by the advertising system.

Referring back to FIG. 1, the NSSE 140 according to an embodiment of the present disclosure performs a neural network task for processing a speech request and symbolic reasoning in order to perform 3D simulations based on provided AI knowledge and the digital twin, and notifies a user of the processing and completion of the requested task by transmitting visual and speech feedback.

The NSSE 140 according to an embodiment of the present disclosure includes a dynamic length audio recorder, a speech-to-text network, a text-to-programs network and a symbolic programs executor.

In the dynamic length audio recorder according to an embodiment of the present disclosure, a user who wears smart glasses triggers the NSSE in order to record his or her audio request. The NSSE detects trigger syntax, invokes the dynamic audio length recording (DLAR) algorithm, and processes the DLAR algorithm so that audio data is generated from a speech signal stream outputted by a microphone.

The dynamic length audio recorder according to an embodiment of the present disclosure uses the DLAR algorithm for recording an audio signal without setting a static time in recording in order to improve an answer time of the system.

The DLAR algorithm according to an embodiment of the present disclosure provides, as an input, a microphone stream having a raw audio format, the number of features to be analyzed from the stream, a threshold for a comparison between data at time-stamps, and a maximum silence time until recording is stopped and obtains, as an output, audio data generated from the stream.

The speech-to-text network according to an embodiment of the present disclosure converts the audio data into text and delivers the text to a text-to-programs network in a speech-to-text form for automatic speech recognition.

The text-to-programs network according to an embodiment of the present disclosure consists of functions and parameters for converting the speech-to-text into an executable program sequence of a domain-specific language.

The text-to-programs network according to an embodiment of the present disclosure converts a word in the text into a request vector by using a general vocabulary for matching the word in the text to a word in an education dataset and converts the request vector into a program vector. The program vector includes referencing to a component of a domain-specific language used to generate a program.

The symbolic programs executor according to an embodiment of the present disclosure notifies the user of the processing and completion of the requested task by transmitting visual and speech feedback to the user.

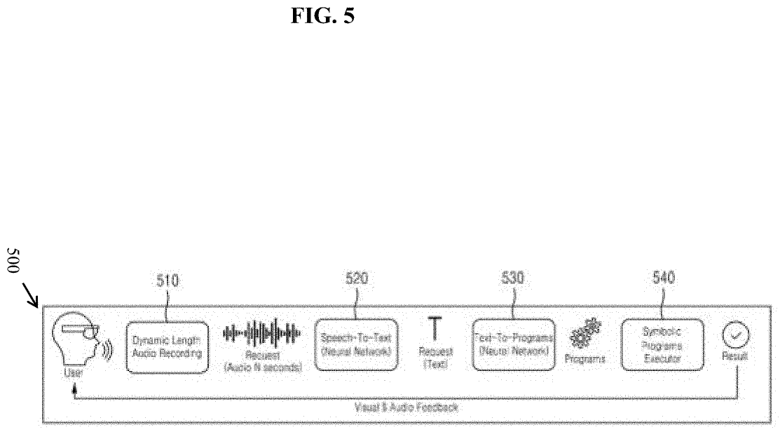

The symbolic programs executor according to an embodiment of the present disclosure uses a program to be executed as an input. Each program consists of functions and corresponding parameters. When iteration for each program of a given program is inputted, the functions and the parameters are extracted. A variable (Prey) that describes the results of previous iteration is added to the parameters. When the functions and the parameters are prepared, execution functions invokes the functions and deliver the extracted parameters. Since each of the functions has a return value, the variable (Prey) is updated in each iteration, and the procedure is applied to all programs. Each of the elements of the NSSE 140 according to an embodiment of the present disclosure is more specifically described with reference to FIGS. 5 to 13.

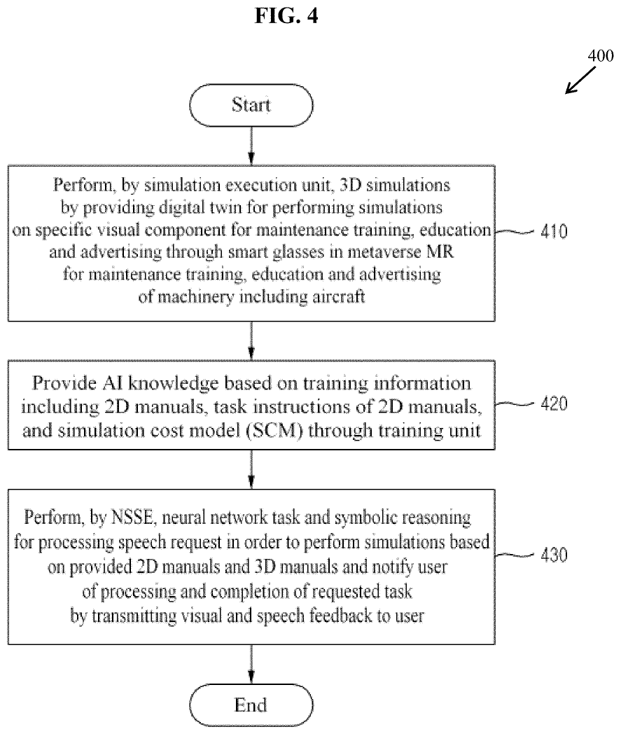

FIG. 4 is a flowchart 400 for describing a complex machinery training, education and/or advertising method in mixed reality (XR) using metaverse according to an embodiment of the present disclosure.

The proposed complex machinery training, education and/or advertising method in MR using metaverse includes step 410 of performing, by the simulation execution unit, 3D simulations by providing a digital twin for performing simulations on a specific visual component for maintenance training, education and/or advertising through smart glasses, step 420 of providing, by the training unit, AI knowledge based on training information including 2D manuals, task instructions of the 2D manuals, and/or the simulation cost model (SCM), and step 430 of performing, by the NSSE, a neural network task and symbolic reasoning for processing a speech request in order to perform simulations based on provided 2D manuals and/or 3D manuals and notifying a user of the processing and completion of the requested task by transmitting visual and speech feedback to the user, in metaverse MR for the maintenance training, education and/or advertising of machinery including an aircraft.

In step 410, in the metaverse MR for the maintenance training, education and/or advertising of machinery including an aircraft, the simulation execution unit provides a digital twin for performing simulations on a specific visual component for maintenance training, education and/or advertising through smart glasses, and performs 3D simulations. In step 420, AI knowledge is provided through the training unit based on training information including 2D manuals, task instructions of the 2D manuals, and the simulation cost model (SCM).

In step 430, in order to perform 3D simulations based on the provided AI knowledge and the digital twin, a neural network task and symbolic reasoning for processing a speech request are performed through the NSSE. A user is notified of the processing and completion of the requested task by transmitting visual and speech feedback to the user.

Step 430 includes steps of, when a user who wears smart glasses triggers the NSSE in order to record his or her audio request, detecting, by the NSSE, trigger syntax, invoking the DLAR algorithm, processing the DLAR algorithm so that audio data is generated from a speech signal stream outputted by a microphone, converting the audio data into text through a speech-to-text network and delivers the text in a speech-to-text form for automatic speech recognition, converting the speech-to-text into an executable program sequence of a domain-specific language through a text-to-programs network consisting of functions and parameters, and notifying the user of the processing and completion of the requested task by transmitting visual and speech feedback to the user through the symbolic programs executor. The detailed steps of step 430 are more specifically described with reference to FIG. 5.

FIG. 5 is a diagram illustrating an operating process 500 of a neuro-symbolic speech executor (NSSE) according to an embodiment of the present disclosure.

The NSSE according to an embodiment of the present disclosure is a module that incorporates the work of neural networks and symbolic reasoning for processing a speech request in the proposed aircraft maintenance metaverse. By combining the superior abilities of deep learning in pattern recognition and traditional AI for reasoning, the NSSE understands complex users' spoken commands having various semantic structures that include aircraft-specific domain vocabulary and various references to legacy maintenance manuals. For example, with respect to “Display AMM document of item 8”, the NSSE recognizes that the aircraft-specific manual AMM should be demonstrated to a user and an item under No. 8 in the document needs to be highlighted to navigate the person.

As in FIG. 5, the NSSE has four steps for performing inference. In step 510, a user who wears smart glasses triggers the NSSE so that his or her audio request is recorded. To this end, a related phrase, such as “Hey, AK!” may be used. The NSSE detects the trigger phrase, invokes the DLAR algorithm, and generates audio data from a stream of speech signals outputted by a microphone.

In step 520, depending on the length of the speech request, the output of the DLAR algorithm is an n-second duration audio request. Next, the audio request is delivered to the Speech-to-Text network. The Speech-to-Text network is a neural network for automatic speech recognition that converts raw audio data into text and extracts the transcript of the request. In step 530, the text-to-program network is a sequence-to-sequence network, and it invokes the transcript of the speech request in the English language and matches the transcript to a sequence of executable programs of the generated domain-specific language consisting of functions and parameters.

In step 540, the symbolic programs executor obtains results by executing the generated programs (in other words, a combination of particular functions and parameters) one by one and notifies the user of the processing and completion of the requested operations by transmitting visual and audio feedback back to the user.

The dynamic length audio recorder according to an embodiment of the present disclosure is described below.

An audio command of the system according to an embodiment of the present disclosure may have various lengths. That is, since a command “Next instruction” is 1.37 seconds and a command “Remove objects 42 and 43 from 46” is 3.94 seconds, it is inefficient to construct an audio recorder that listens only a specified amount of time. If possible speech requests (45,244 requests) are analyzed, an average length thereof is 2.76 seconds and a standard deviation is 0.87 seconds, the shortest speech request is 0.54 seconds, and the longest speech request is 7.61 seconds. In the case of a static audio recorder approach, listening time should be set as a maximum time in order to handle all requests. Thus, a total time for 45,244 speech commands will be 344,306.84 seconds (45,244×7.61), and an average time to be wasted is 4.85 seconds because even though a speaker finished a request, static recording continues to listen until the defined time.

In the present disclosure, in order to improve a response time of the system, there is proposed the DLAR algorithm, that is, a dynamic algorithm capable of recording audio signals without setting a static time for recording. Logic of the DLAR algorithm is described in Algorithm 1.

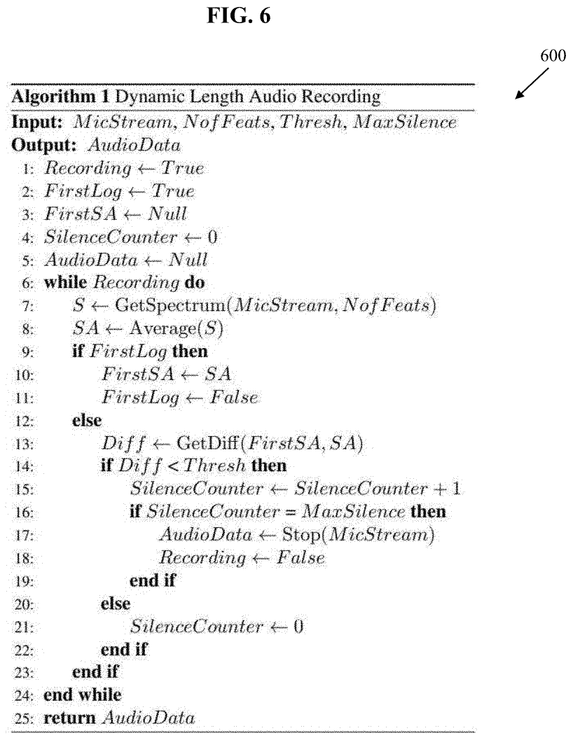

FIG. 6 is a diagram illustrating a DLAR algorithm 600 according to an embodiment of the present disclosure.

A microphone stream having a raw audio format, a number of features to be analyzed from the stream, a threshold for a comparison between data at time-stamps, and a maximum silence time until recording is stopped are provided as an input to the algorithm. Audio data generated from the stream is obtained as an output. According to Algorithm 1, while recording audio (line 6) is performed, for every iteration of the entire loop being executed every 0.02 seconds, a spectrum average of a small chunk of audio data from a microphone stream (lines 7-8) is calculated and a difference in a current spectrum average is compared with a spectrum average of the first chunk (line 13). When the calculated difference is less than a given threshold (line 14), silence occurs and a silence counter is increased (line 15). If not, the counter is set to 0 (line 21). Whenever the silence reaches the maximum silence time, the recording is stopped (line 16), and audio data is generated from the stream (lines 17-18). In this work, the silence time was set to 1.5 seconds so that the DLAR algorithm can listen to a user's speech request until 1.5-second silence occurs.

When comparing the proposed dynamic approach DLAR algorithm with the static approach, a recording time was 192,632.74 seconds in the case of possible 45,244 requests, whereas a recording time was 344,306.84 seconds in the case of the static approach. In the case of the DLAR algorithm, a wasting time for all requests was 1.5 seconds, whereas a wasting time for all requests in the static approach was on average 4.85 seconds. When overall time efficiency is evaluated, the DLAR algorithm was 44.05% more efficient than the static approach, which considerably speeds up inference and a response time of the system.

When the request speech signal is converted into audio data, the audio data is transmitted to the automatic speech recognizer model for further processing.

Speech-to-text according to an embodiment of the present disclosure is an automatic speech recognition neural network that takes audio data and extracts spoken text from the speech. This is based on a wav2vec2.0 network. Speech-to-text plays a vital role in the system because it generates a transcript text of an audio signal and performance of the model directly affects next stages of inference in the NSSE.

Regarding architecture, the wav2vec2.0 framework accepts a raw waveform of a speech signal, generates representations to be processed by Connectionist Temporal Classification, and writes a transcript of the signal. The model encodes speech audio over a multi-layer convolutional neural network and then masks spans of the resulting latent speech representations similar to masked language modeling to be contextualized later using the transformer. In this case, a self-attention mechanism finds relationships in the sequence of latent representations in an end-to-end manner.

In the case of Aircraft Maintenance Metaverse, there exists a professional vocabulary including aircraft maintenance-specific words and terms. Accordingly, the existing models of wav2vec2.0 trained on general datasets may not work properly even though the models are in English. However, it was assumed that it is more effective to fine-tune a pre-trained model, rather than training wav2vec2.0 from scratch, because ASR tasks require a vast amount of data. Accordingly, in the present disclosure, in order for the NSSE to generate Speech-to-Text, the issues of enormous datasets collection is solved by fine-tuning wav2vec2.0 pre-rained on general datasets such as Libri Speech. Next, a generated transcript of a speech request in the form of text is transmitted to the Text-To-Programs for corresponding processing.

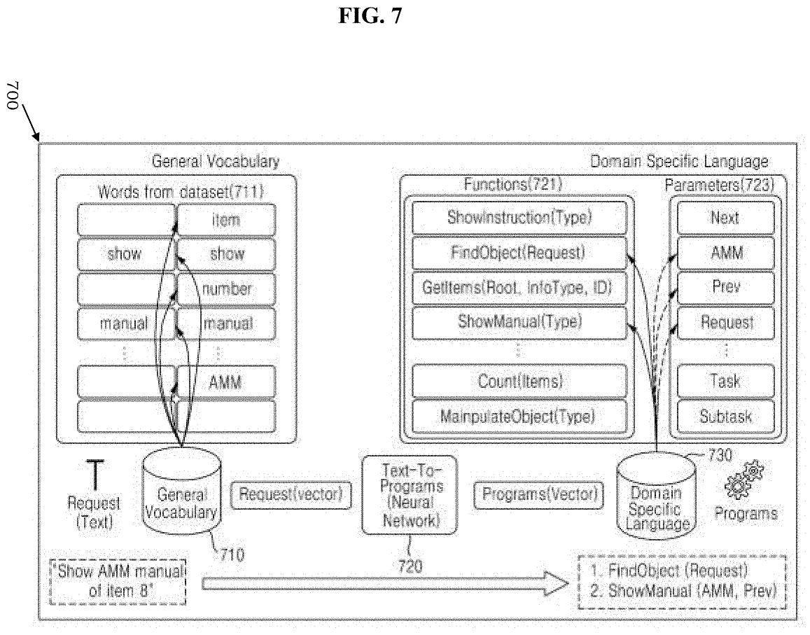

FIG. 7 is a diagram illustrating an operating process 700 of a text-to-programs network according to an embodiment of the present disclosure.

The text-to-programs network component of the NSSE according to an embodiment of the present disclosure is a deep learning sequence-to-sequence model that converts text of a spoken command into a series of programs. In the system, a program is a notation for a certain piece of code and is a function including its own parameters. Accordingly, a main intuition behind Text-To-Programs is to translate text of a request into a sequence of machine functions having parameters to be executed.

Referring to FIG. 7, such a system has knowledge of General Vocabulary 710, that is, words 711 from possible users' requests, and a domain-specific language 730 that represents machine known words, such as the existing functions 721 and parameters 722 to be used for a programs construction. Accordingly, request text is converted into a Request Vector with the help of the General Vocabulary that matches the words of the text to the words 711 from a training dataset. Next, the text-to-programs network converts the Request Vector into Programs Vector. The Programs Vector includes references to the components of the Domain-Specific Language to be used to generate programs. Accordingly, example request text “Show AMM manual of item 8” is converted into programs “FindObject(Request)” and “ShowManual(AMM, Prev)”.

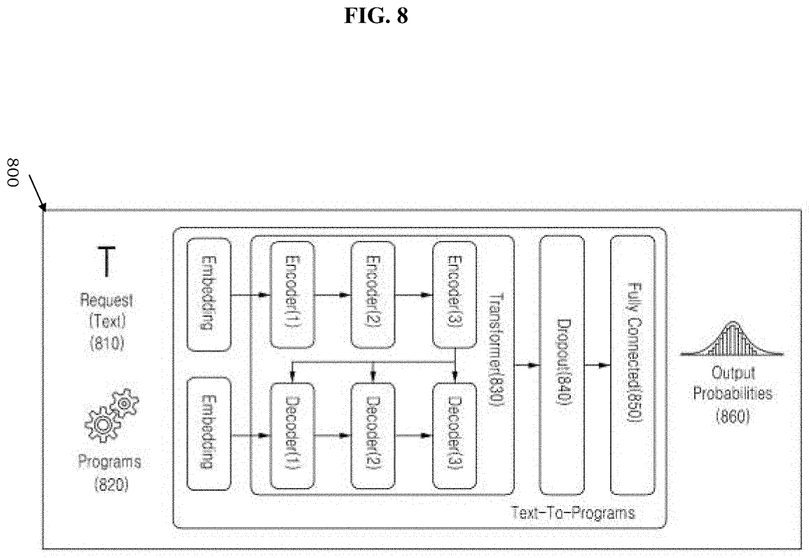

FIG. 8 is a diagram illustrating architecture 800 of the text-to-programs network according to an embodiment of the present disclosure.

The architecture of the text-to-programs network is based on Transformer 830. The Transformer 830 has an encoder-decoder type structure and is very suitable for translation tasks. FIG. 8 illustrates the architecture of the Text-To-Programs network. If a request text input 810 and a programs input 820 include respective word embedding layers having 256 dimensions, embedding vectors thereof are combined with positional information of respective words in the form of positional encoding before being supplied to encoders and decoders. In this work, the architecture consists of three identical encoders, which map given sequences into representations of learned information for the given sequence, and three respective decoders, which generate text sequences, worked best with 8 multi-headed attention layers. Overall, a request vocabulary size is 89, whereas a programs vocabulary dimension is 49. The output of the transformer is received from Dropout 0.3 840 and a fully connected layer 850 without activation to obtain output probabilities.

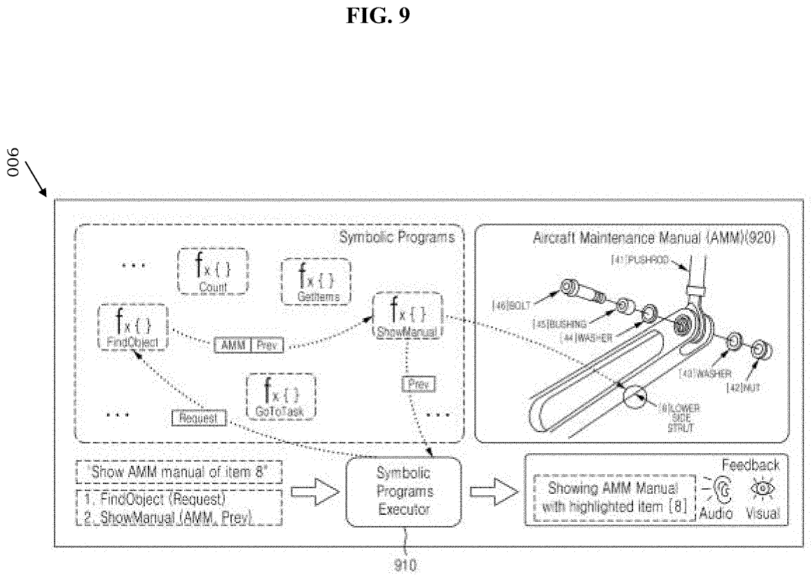

In terms of architecture, comparing with conventional LSTM, in the present disclosure, the transformer is applied. The conventional LSTM is inefficient in speed because in order to generate embeddings for a particular item in a sequence, the representations of all previous words need to be calculated and thus a computation process cannot be parallelized for running on graphics processing units (GPUs). On the contrary, the transformer model may be trained and executed across multiple GPUs by using a parallelism pipeline. Furthermore, the conventional LSTM lacks contextualization because it comprehends the meaning of a token according to tokens that come before, but does not comprehend the meaning of a token according to tokens that come after. However, in the transformer, all tokens in a sequence are merged with other tokens in the corresponding sequence at the same time, thereby making the context clear. Finally, a generated program 860 passes through the last part of the processing of the NSSE. FIG. 9 is a diagram illustrating an operating process 900 of a symbolic programs executor according to an embodiment of the present disclosure.

A symbolic programs executor 910 according to an embodiment of the present disclosure is a component of the NSSE for executing a program generated from the text-to-programs network and providing a user with visual and audio feedback.

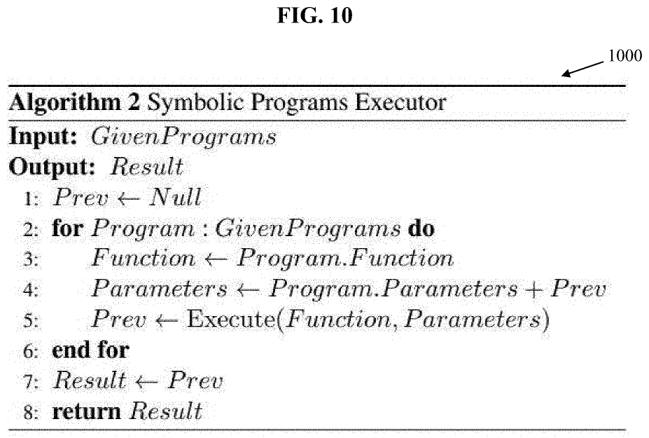

FIG. 10 is a diagram illustrating a symbolic programs executor algorithm 1000 according to an embodiment of the present disclosure.

Algorithm 2 describes a process of a Symbolic Programs Execution process. As an input, the algorithm uses programs that have to be run. Each program consists of a function and its corresponding parameters. When an iteration (line 2) is inputted for each program in given programs, a function and parameters are extracted (lines 3-4). Next, a variable (Prey) describing the result of a previous iteration is appended to the parameters. When functions and parameters are ready, an Execute function invokes each function and transfers extracted parameters (line 5). Each function has a return value, and thus in each iteration, the variable (Prey) is updated (line 5). The above procedure is applied to all the programs. In this case, the last value of the variable (Prey) describes an overall result of the execution (line 7). Types of return functions are different and generated according to the needs.

Considering the example “Show me AMM manual of item 8” in FIG. 9, the corresponding programs are “FindObject(Request)” and “ShowManual(AMM, Prev)”. In this case, there are two programs that need to be executed sequentially by the symbolic programs executor. In the system, there is a symbolic programs space. The symbolic programs executor matches an instance of machine code and generated programs and invokes execution. In FIG. 9, first, the function FindObject is invoked, and takes a request parameter representing the transcript of a command (in other words, the result from the Speech-To-Text network). The function FindObject is a function for finding a number from given text and returns the number.

Accordingly, after this program is executed, a variable (Prey) becomes 8 because 8 is the number mentioned in the example. Next, the function ShowManual having parameters AMM and the variable (Prey) is invoked by using the return value of the function FindObject. The function ShowManual is a function that displays a particular type of manual and highlights the number therein. In this case, the type of manual is AMM, and the number to be highlighted is the variable (Prey) having the value 8 now. All functions in the domain-specific language have their own duty, some of the functions return processed computational operations, and some of the functions perform validation, etc.

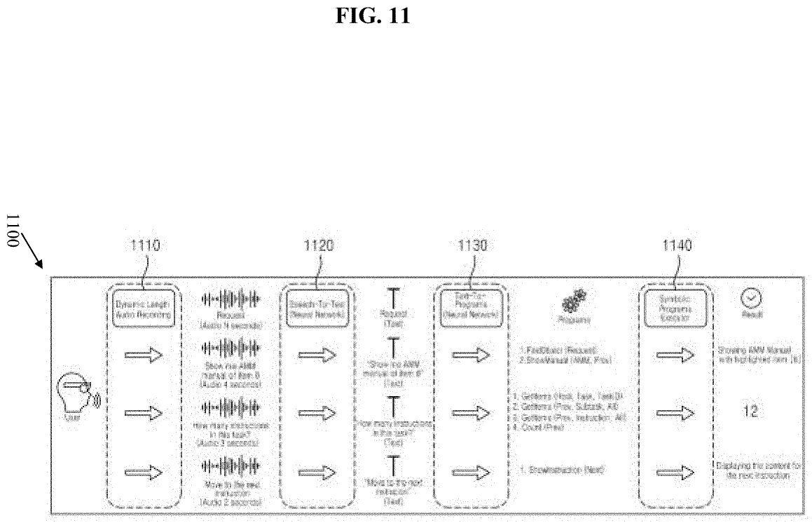

FIG. 11 is an example illustrating a process 1100 from a sample user request to results according to an embodiment of the present disclosure. When the processing of all the programs is finished, the symbolic programs executor processes feedback to users, thereby enhancing user experience by notifying the users of an ongoing procedure of playing back and displaying the manual both visually (e.g., in the form of text and icons) and vocally.

When all the components of the NSSE according to an embodiment of the present disclosure are combined together, a sample request, such as FIG. 11, is provided. A speech request having various duration is processed by a dynamic length audio recording (DLAR) algorithm 1110 and transcribed by a Speech-To-Text model 1120. Next, a text-to-programs network 1130 generates programs having various complexity and sizes. It may be seen that the text-to-programs network 1130 has generated four interconnected programs. In this case, a function Getltems obtains information from a JSON knowledge file and extracts a task with certain identification. Next, a symbolic programs executor 1140 extracts all subtasks. The symbolic programs executor 1140 finds all instructions from subtasks because a task contains the subtasks. When all items are prepared, that is, a mathematical program count that is a node having all instructions, counts items in a previous computed operation, and provides a proper answer to a request for an exact number of instructions.

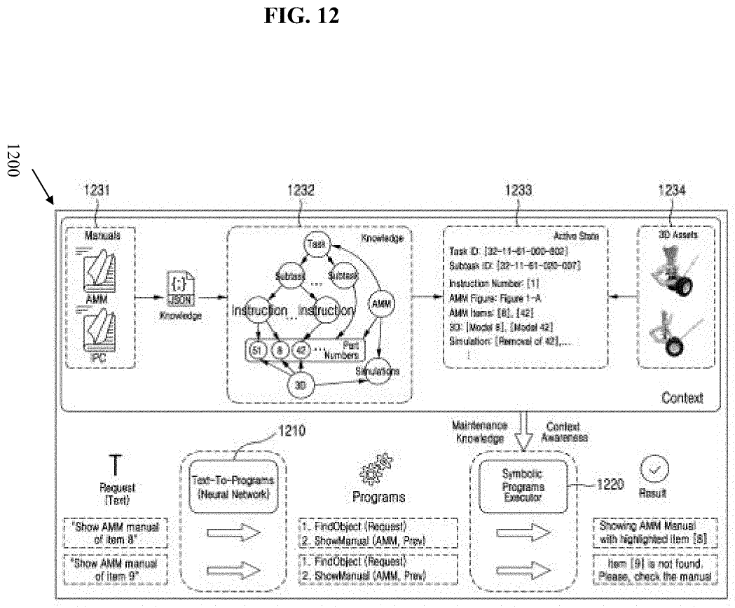

The work of the NSSE is based on neuro-symbolic AI, which combines advantages of neural processing and symbolic reasoning for processing various contextual speech requests. FIG. 12 is a diagram for describing the context management 1200 of the NSSE according to an embodiment of the present disclosure.

In order to process a speech request from a user and reply according to specific context, it is effective to construct a system based on neuro-symbolic reasoning. When the neural components of the NSSE perform complex pattern recognition in speech, a symbolic part provides proper replies and manages context and knowledge for validating the user's request.

In FIG. 12, context management 1200 in the NSSE is illustrated. First, all the existing manuals 1231, such as AMM and IPC, are structured in a JSON format that provides accessible and cross-referenced knowledge. The Aircraft Maintenance knowledge 1232 encapsulates all components, construction relations, and dependencies. In the example FIG. 12, various task nodes have multiple subtasks of AMM. At the same time, subtask nodes refer to aircraft-specific part numbers, such as items 51, 8, and 42 from the manual, and need to have their own 3D models 1234 equipped with simulation procedures described in AMM. In addition to references to 3D virtual assets and Aircraft Maintenance knowledge into an Active State 1233, information is taken from JSON. The information includes various environmental variables and links, such as a current task, subtasks and instruction information, available annotations in the AMM manual, 3D assets used in a current scene, simulations, and/or the like. All these contents generate context that has to be followed and considered when the NSSE processes speech commands.

For example, in the case of a Text-To-Programs neural network 1210 of the NSSE for requests “Show me AMM manual of item 8” and “Show me AMM manual of item 9” in FIG. 12, a symbolic programs executor 1220 generates identical generated programs, but validates the requests based on context, available 3D assets, and overall knowledge and provides the final answer. When considering AMM items in FIG. 12 as current context, a request of item 8 is valid, but an item 9 is not present in the AMM annotations, and thus corresponds to feedback to a user.

In the neural part of semantics, when the text-to-programs network 1210 converts request text to machine-understandable programs, contextual information is not considered. The text-to-programs network 1210 notifies the symbolic programs executor 1220 what steps needs to be performed in order to obtain the result. However, symbolic reasoning occurs while programs including the context-based validation procedure are executed. Accordingly, it is essential to have both neural and symbolic parts work together.

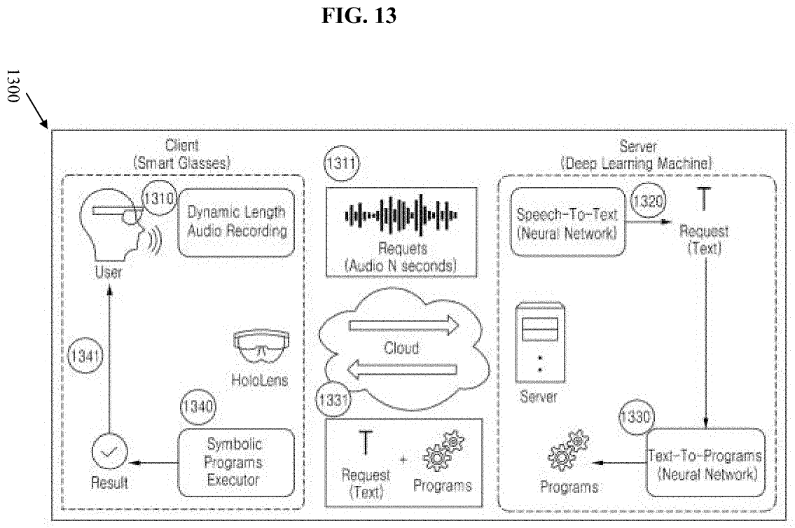

FIG. 13 is a diagram illustrating architecture 1300 of the NSSE according to an embodiment of the present disclosure.

The NSSE is a system including four major components located across two devices including client-server architecture. FIG. 13 describes the system architecture 1300 of the NSSE, and includes a client machine, that is, user's smart glasses, and a server, that is, a deep learning machine that processes all types of processing. The client of the system according to an embodiment of the present disclosure runs on the smart glasses HoloLens 2 and is responsible for generating speech requests and processing generated programs. In contrast, the server works with neural networks, converts audio data into text by using the speech-to-text network, and converts text into programs by using the text-to-programs network. The two machines exchange data through communication through the internet. The client transmits audio data, and the server forwards a transcript including generated programs back to the client. The following steps details a procedure of inference.

The DLAR algorithm located on the client side generates an audio request by using the microphone of the smart glasses (1310).

Audio data is transmitted the server machine over a web (1311).

The received audio data is processed by the speech-to-text network, so that a transcript of the request is extracted (1320).

The text-to-speech network converts the transcript into a set of programs (1330).

The request text and the generated programs are transmitted back to the client (1331).

The symbolic programs executor processes the programs (1340).

Generated result including audio and visual feedback is demonstrated to the user (1341).

This architecture 1300 guarantees that a client device, that is, the smart glasses, is not overloaded with computational processing because the two neural networks are included in the system without considering other 3D assets. Accordingly, a powerful machine having a GPU is installed and processes speech requests from devices fast and efficiently. In addition, the speech processing module can be separated from a device easily maintained and updated, and can provide services for applications constructed on different platforms, such as smartphones, a PC, and tablets.

In the examples of the tasks used in the conventional technologies, neuro-symbolic AI on problems, such as identifying what kind of a shape, color, relations a particular object has in an image, is considered. The present disclosure illustrates that the concept of neuro-symbolic AI can be applied to the industry in order to solve a real-world problem. In other words, the concept of neuro-symbolic AI processes complex semantic structure speech requests that refers to contextual knowledge and environments. Approaches are compared with one another in the visual understanding and question answering suggested in the conventional technologies. However, in the present disclosure, an audio signal is processed in order to understand what a question is, and functional programs are generated based on a given question and executed on aircraft-related knowledge. Furthermore, in the conventional technology, an image is parsed to extract structural scene representation of visual data in order to execute functional programs. However, in the present disclosure, such representations are generated in a JSON file form that summarizes the knowledge from maintenance manuals. Nevertheless, the two techniques guarantee the transparency of a reasoning process. This provides the opportunity to trace various problems and find explainable reasons for them, and is crucial for systems used in the industry. The aircraft maintenance training and education method and system using metaverse according to an embodiment of the present disclosure constructs a next-generation collaborative virtual space called aircraft maintenance metaverse that may potentially revolutionize a training and education process in aviation colleges. The proposed metaverse includes all of required resources for the MRO of an aircraft, such as legacy manuals, 3D models and simulations, aircraft knowledge, and an established maintenance flow, and reduces a huge amount of resources by replacing physical aircrafts for training with virtual aircrafts. Furthermore, colleges use outdated models of aircraft for education due to the lack of resources, but can easily maintain the newest up-to-date knowledge along with the metaverse.

According to an embodiment of the present disclosure, there is proposed to construct a 3D simulator having new dimensions for the existing knowledge in order to enhance the existing aircraft maintenance manuals. The 3D manuals replicate the 2D AMM manual and add animations and a step-by-step control execution function. In general, a figure presented in 2D manuals depicts information only in one perspective, that is, a static viewpoint, but the proposed 3D manual enables full-side observation and interactions.

According to an embodiment of the present disclosure, in order to navigate and control an operational flow in the metaverse, there is provided speech communication called the NSSE for interacting with the 3D manual. As described above, the present disclosure can push forward the concept of neuro-symbolic AI by constructing context-aware speech understanding that may reason based on aircraft maintenance knowledge.

The aforementioned device may be implemented as a hardware component, a software component and/or a combination of a hardware component and software component. For example, the device and component described in the embodiments may be implemented using a processor, a controller, an arithmetic logic unit (ALU), a digital signal processor, a microcomputer, a field programmable gate array (FPGA), a programmable logic unit (PLU), a microprocessor or one or more general-purpose computers or special-purpose computers, such as any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, a component, a physical device, a computer storage medium or a device in order to be interpreted by the processor or to provide an instruction or data to the processing device. The software may be distributed to computer systems connected over a network and may be stored or executed in a distributed manner. The software and the data may be stored in one or more computer-readable recording media. The method according to embodiments may be implemented in the form of a program instruction executable by various computer means and stored in a computer-readable medium. The computer-readable medium may include a program instruction, a data file, and a data structure solely or in combination. The program instruction stored in the medium may be specially designed and constructed for an embodiment, or may be known and available to those skilled in the computer software field. Examples of the computer-readable medium include magnetic media such as a hard disk, a floppy disk and a magnetic tape, optical media such as a CD-ROM and a DVD, magneto-optical media such as a floptical disk, and hardware devices specially configured to store and execute a program instruction, such as a ROM, a RAM, and a flash memory. Examples of the program instruction include not only machine language code produced by a compiler, but a high-level language code which may be executed by a computer using an interpreter, etc.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as the system, configuration, device, and circuit, are coupled or combined in a form different from that of the described method or replaced or substituted with other components or equivalents.

Accordingly, other implementations, other embodiments, and the equivalents of the claims fall within the scope of the claims.

1. A system in mixed reality (XR) using a metaverse platform, the system comprising:
a simulation execution unit configured to perform three-dimensional (3D) simulations in a metaverse mixed reality (MR) by providing a digital twin for performing simulations on a specific visual component for at least one of maintenance training, education and advertising of machinery comprising an aircraft through smart glasses;
a training unit configured to provide artificial intelligence (AI) knowledge based on training information comprising at least one of two-dimensional (2D) manuals, task instructions of the 2D manuals, and a simulation cost model (SCM); and
a neuro-symbolic speech executor (NSSE) configured to perform a neural network task and symbolic reasoning for processing a speech request in order to perform the 3D simulations based on the provided AI knowledge and the digital twin and to notify a user of the processing and completion of the requested task by transmitting visual and speech feedback to the user.

2. The system of claim 1, wherein the NSSE comprises:
a dynamic length audio recorder configured to detect a trigger syntax when a user who wears smart glasses triggers the NSSE in order to record his or her audio request, invoke a dynamic audio length recording (DLAR) algorithm and to process the DLAR algorithm so that audio data is generated from a speech signal stream outputted by a microphone;
a speech-to-text network configured to convert the audio data into text and deliver the text to a text-to-programs network in a speech-to-text form for automatic speech recognition, wherein the speech-to-text network is an automatic speech recognition neural network;
the text-to-programs network consisting of functions and parameters and configured to convert the speech-to-text into an executable program sequence of a domain-specific language; and
a symbolic programs executor configured to notify the user of the processing and completion of the requested task by transmitting visual and speech feedback to the user.

3. The system of claim 2, wherein:
the text-to-programs network converts a word in the text into a request vector by using a general vocabulary for matching the word in the text to a word in an education dataset and converts the request vector into a program vector, and
the program vector comprises referencing to a component of the domain-specific language used to generate a program.

4. The system of claim 2, wherein the symbolic programs executor:
uses programs to be executed as an input, wherein each of the programs consists of functions and corresponding parameters, extracts functions and parameters when an iteration is inputted with respect to each of given programs, appends a variable (Prey) describing a result of a previous iteration to the parameters, invokes the respective functions when functions and parameters are prepared and delivers the extracted parameters through Execute functions, and updates the variable (Prey) in each iteration because each function has a return value, and the symbolic programs executor comprises a context management unit for performing a given command based on knowledge extracted from manuals and applying the procedure to a program.

5. A method in mixed reality (MR) using a metaverse platform, the method comprising steps of:
performing, by a simulation execution unit, three-dimensional (3D) simulations in a metaverse mixed reality (MR) by providing a digital twin for performing simulations on a specific visual component for at least one of maintenance training, education and advertising through smart glasses;
providing, by a training unit, artificial intelligence (AI) knowledge based on training information comprising at least one of two-dimensional (2D) manuals, task instructions of the 2D manuals, and a simulation cost model (SCM); and
performing, by a neuro-symbolic speech executor (NSSE), both a neural network model and symbolic AI knowledge reasoning for processing a speech request in order to perform the 3D simulations based on the provided AI knowledge and the digital twin and notifying a user of the processing and completion of the requested task by transmitting visual and speech feedback to the user.

6. The method of claim 5, wherein the step of performing a neural network model and symbolic AI knowledge reasoning comprises steps:
detecting, by a dynamic length audio recording (DLAR) algorithm, a trigger syntax when a user who wears smart glasses triggers the NSSE in order to record his or her audio request, invoking the DLAR algorithm, and processing the DLAR algorithm so that audio data is generated from a speech signal stream outputted by a microphone;
converting, by a speech-to-text network, the audio data into text and delivering the text to a text-to-programs network in a speech-to-text form for automatic speech recognition, wherein the speech-to-text network is an automatic speech recognition neural network;
converting, by the text-to-programs network consisting of functions and parameters, the speech-to-text into an executable program sequence based on AI domain knowledge; and
notifying, by a symbolic programs executor, the user of the processing and completion of the requested task by transmitting visual and speech feedback to the user.

7. The method of claim 6, wherein the step of converting, by the text-to-programs network consisting of functions and parameters, the speech-to-text into an executable program sequence based on AI domain knowledge comprises:
converting a word in the text into a request vector by using a general vocabulary for matching the word in the text to a word in an education dataset, and converting the request vector into a program vector, and the program vector comprises referencing to a component of the domain-specific language used to generate a program.

8. The method of claim 6, wherein:
the step of notifying, by a symbolic programs executor, the user of the processing and completion of the requested task by transmitting visual and speech feedback to the user comprises using programs to be executed as an input, wherein each of the programs consists of functions and corresponding parameters, extracting functions and parameters when an iteration is inputted with respect to each of given programs, appends a variable (Prey) describing a result of a previous iteration to the parameters, invoking the respective functions when functions and parameters are prepared and delivers the extracted parameters through Execute functions, and updating the variable (Prey) in each iteration because each function has a return value, and a context management unit performs a given command based on knowledge extracted from manuals and applies the procedure to a program.
